(19) United States
(12) Patent Application Publication
(10) Pub. No.: US 2016/0179936 A1
(43) Pub. Date: Jun. 23, 2016

(54) PROCESSING TIME-ALIGNED, MULTIPLE FORMAT DATA TYPES IN INDUSTRIAL APPLICATIONS

(71) Applicant: GE Intelligent Platforms, Inc., Charlottesville, VA (US)

(72) Inventors: Sunil MATHUR, East Walpole, MA (US); Michael SOLDA, Iron Mountain, MI (US); Ryan David CAHALANE, Charlottesville, VA (US); Amy WOOTEN, Foxboro, MA (US)

(21) Appl. No.: 14/903,873

(22) PCT Filed: Jul. 8, 2014
(86) PCT No.: PCT/US14/45650

§ 371 Date: Jan. 8, 2016

Related U.S. Application Data
(60) Provisional application No. 61/843,469, filed on Jul. 8, 2013.

(51) Int. Cl. G06F 17/30

(52) U.S. Cl. CPC G06F 17/30657; G06F 17/30312

(57) ABSTRACT

A method of performing data management in a high-speed data environment. The method includes collecting time-series information including multiple data types captured concurrently, and storing the collected time-series information in a process historian with organization, the organization occurring when the multiple data types are captured.

### FIELD OF THE INVENTION

Embodiments of the present invention relate generally to processing time series data. More particularly, embodiments of the present invention relate to efficiently processing time series data having multiple data formats.

### BACKGROUND OF THE INVENTION

Advances in technology have enabled the development of increasingly complex systems. Accordingly, equipment maintenance within the systems has evolved over the years from purely corrective maintenance, which reacts to equipment breakdowns, to a wide range of analyses including predictive analysis, anomaly detection, fault diagnostics, and system prognostics. Anomaly detection is used to detect early signs of system anomalies, to allow for timely maintenance actions to be taken before a potential fault progresses, causing secondary damage and equipment downtime. Fault diagnostics refer to a detection of a fault condition or an observed change in an operational state in a piece of equipment that is related to an event. System prognostics refer to the estimation of remaining useful life for a piece of equipment. Many of these analyses utilize data-driven approaches.

The system components generally are monitored by a plurality of sensors that provide data measurements, which represent one or more observations or performance characteristics. These data measurements may be utilized by the analyses above.

Through the use of the sensors, the system monitors numerous parameters and collects in real time a vast amount of data. In order to perform the analyses, this data often needs to be quickly analyzed. Faster response to time series queries, especially regarding the operating parameters of a malfunctioning component, enables analysts and system operators to identify and solve problems earlier, particularly in the case of remote monitoring and diagnostics.

Queries dealing with massive amounts of time series data can be time-consuming and processing-intensive. Oftentimes, numerous time series queries overlap, because they request the same set of data, and require the system to repeatedly conduct the same search. Organizing and storing the data in manner such that it is quickly accessible is especially useful for providing real-time visualization capabilities. Additionally, in many cases, this provides better resource allocation by freeing up processing resources for other uses.

Additionally, in industrial environments, information is often received and stored with the objective to process and analyze as a single logical unit, with the ability to decompose into its component elements where required. In a traditional time-series data store, data is received and stored into individual tags which may contain a timestamp, data and data quality. There is no concept of a structure, and limited ability to inter-relate tags of different data types.

In order to process “structured” information, a user needs to be aware of the various component elements and aggregate the information via their query, and if the information doesn't all have the identical timestamp then samples may be excluded. With the capability described, users can retrieve information that is naturally structured without the burden of developing detailed queries or risk of missing information that may be critical to analysis.

### SUMMARY OF THE INVENTION

Given the aforementioned deficiencies, a need exists for a method and system to aggregate a fixed set of data elements into a single logical structure with a common time-stamp, where the individual elements can be multiple data types (integer, string, blob, etc.). Also, in this environment, the information within the structure can be created, updated, deleted and accessed in aggregate or at an individual level.

A need also exists for creating an ability to (i) define new structures from existing data (primitive types or other previously defined structures) and (ii) change a structure to add a new element, rearrange elements, or include a nested structure containing other structures. In the embodiments, a user can understand which structure a particular element is contained within, and where within the sequence of components in the structure, by accessing the component element.

One embodiment includes a method of performing data management in a high-speed data environment. A high-speed environment can include, for example, and without limitation, performing read and write commands in excess of 3 million samples/second, totaling over 6 million operations/second. The method includes collecting time-series information including multiple data types captured concurrently, and storing the collected time-series information in a process historian with organization, the organization occurring when the multiple data types are captured.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

FIG. 1A illustrates a gas turbine engine for use with the cache system according to the present disclosure.

FIG. 1B illustrates a schematic diagram of the gas turbine engine of FIG. 1A and depicts an embodiment of a cache system including the gas turbine engine.

FIG. 2 is an illustration of multi-field dynamic array tags in accordance with the present disclosure.

FIG. 3 is a more detailed illustration of an array in connection with the illustration of FIG. 2.

FIG. 4 is a more detailed illustration of a multi-field tag in connection with the illustration of FIG. 2.

FIG. 5 is an illustration of a multi-field and array tag table in accordance with the embodiments.

FIG. 6 is a first example of arrays using excel in accordance with the present disclosure.

FIG. 7 is a second example of arrays using excel in accordance with the present disclosure.

FIG. 8 is a third example of arrays using excel in accordance with the present disclosure.

FIG. 9 is an illustration of using multi-field in an interactive structured query language (SQL) environment in accordance with the embodiments.

FIG. 10 is a first illustration of a process flow diagram constructed in accordance with the embodiments.

FIG. 11 is a second illustration of a process flow diagram constructed in accordance with the embodiments.

Embodiments of the present invention may take form in various components and arrangements of components, and in various process operations and arrangements of process operations. The present disclosure is illustrated in the accompanying drawings, throughout which, like reference numerals may indicate corresponding or similar parts in the various figures. The drawings are only for purposes of illustrating embodiments and are not to be construed as limiting the disclosure. Given the following enabling description of the drawings, the novel aspects of the present disclosure should become evident to a person of ordinary skill in the art.

### DETAILED DESCRIPTION

The following detailed description is merely exemplary in nature and is not intended to limit the applications and uses disclosed herein. Further, there is no intention to be bound by any theory presented in the preceding background or summary or the following detailed description.

In at least one embodiment, the cache system and method include a processor, a database, and a plurality of sensors in communication with the processor. The processor defines, based on a query definition, a time series query for which to create cached views. The processor creates a view of the time series query based on the query definition. The processor stores the view in a cache and persists the view to a data store.

The processor also automatically updates the view as incoming time series data arrives by incorporating the incoming time series data into the view. The processor enables incoming time series queries to access the view stored in the cache and determines whether the incoming time series query can be fulfilled by the cache views. The processor segments the time series query when the time series query can be partially fulfilled by the cached views.

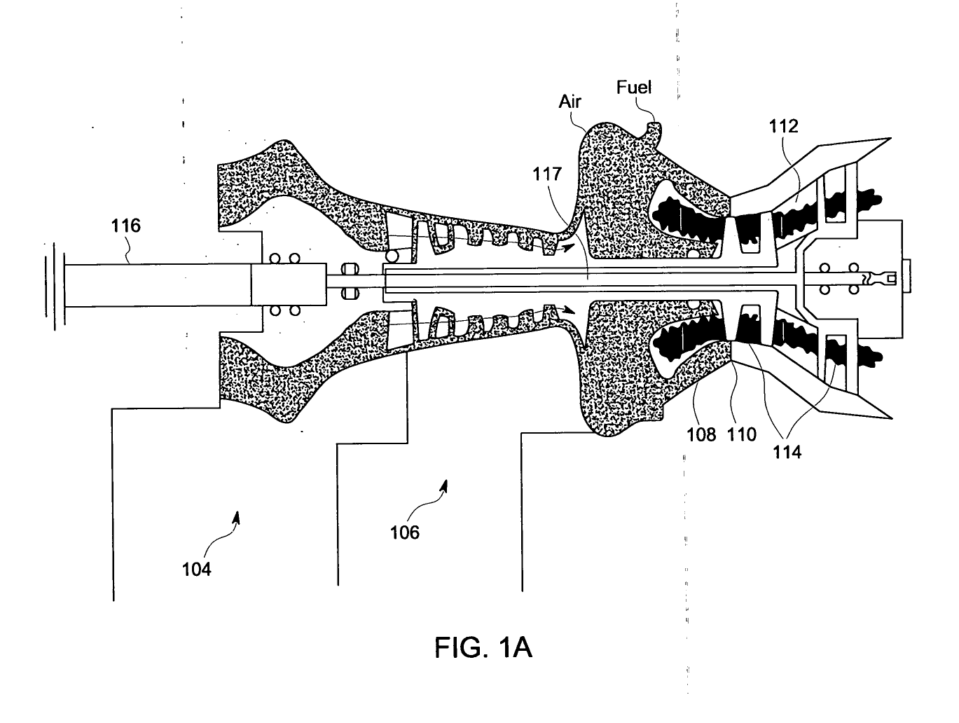

FIGS. 1A and 1B illustrate an embodiment that relates to a system and method for caching time series data of a component being monitored.

In a particular embodiment, and as will be described in greater detail below, the component being monitored by a cache system is a gas turbine engine. It should be noted that the gas turbine engine component in the cache system describes an embodiment. Those skilled in the art will appreciate that the disclosed cache system is not limited to a gas turbine engine in particular, and may be applied, in general, to a variety of systems or devices, such as, for example, locomotives, aircraft engines, automobiles, turbines, computers, appliances, spectroscopy systems, nuclear accelerators, medical equipment, biological cooling facilities, and power transmission systems, to name but a few.

FIGS. 1A-1B illustrate a cache system 100 for a gas turbine engine 102, which is used to power, for example, a helicopter (not shown). Gas turbine engine 102 comprises an air intake 104, a compressor 106, a combustion chamber 108, a gas generator turbine 110, a power turbine 112, and an exhaust 114.

At the air intake 104, air is suctioned through the inlet section by the compressor 106. Air filtration occurs in the inlet section via particle separation. Air is then compressed by the compressor 106 where the air is used primarily for power production and cooling purposes. Fuel and compressed air is burned in the combustion chamber 108 producing gas pressure, which is directed to the different turbine sections 110, 112.

Gas pressure from the combustion chamber 108 is blown across the gas generator turbine rotors 110 to power the engine and blown across the power turbine rotors 112 to power the helicopter. The two turbines 110, 112 operate on independent output shafts 116, 117. Hot gases exit the engine exhaust 114 to produce a high velocity jet.

One or more sensors 118 are attached at predetermined locations 1, 2, 3, 4, and 5 to the gas turbine engine 102. Sensors 118 may be integrated into a housing of the gas turbine 102 or may be removably attached to the housing. Each sensor 118 can generate sensor data that is used by the cache system 100. In general, a “sensor” is a device that measures a physical quantity and converts it into a signal which can be read by an observer or by an instrument. In general, sensors can be used to sense light, motion, temperature, magnetic fields, gravity, humidity, vibration, pressure, electrical fields, sound, and other physical aspects of an environment.

Non-limiting examples of sensors can include acoustic sensors, vibration sensors, vehicle sensors, chemical sensors/detectors, electric current sensors, electric potential sensors, magnetic sensors, radio frequency sensors, environmental sensors, fluid flow sensors, position, angle, displacement, distance, speed, acceleration sensors, optical, light, imaging sensors, pressure sensors and gauges, strain gauges, torque sensors, force sensors piezoelectric sensors, density sensors, level sensors, thermal, heat, temperature sensors, proximity/presence sensors, etc.

Sensors 118 provide sensor data to a monitoring device 120. The monitoring device 120 measures characteristics of the gas turbine engine 102, and quantifies these characteristics into data that can be analyzed by a processor 132. For example, the monitoring device may measure power, energy, volume per minute, volume, temperature, pressure, flow rate, or other characteristics of the gas turbine engine. The monitoring device may be a suitable monitoring device such as an intelligent electronic device (IED). As used herein, the monitoring device refers to any system element or apparatus with the ability to sample, collect, or measure one or more operational characteristics or parameters of the cache system.

The monitoring device 120 includes a controller 122, firmware 124, memory 126, and a communication interface 130. The firmware 124 includes machine instructions for directing the controller 122 to carry out operations required for the monitoring device. Memory 126 is used by the controller 122 to store electrical parameter data measured by the monitoring device 120.

Instructions from the processor 132 are received by the monitoring device 120 via the communications interface 130. In various embodiments, the instructions may include, for example, instructions that direct the controller 122 to mark the cycle count, to begin storing electrical parameter data, or to transmit to the processor 132 electrical parameter data stored in the memory 126. The monitoring device 120 is communicatively coupled to the processor 132. One or more sensors 118 may also be communicatively coupled to the processor 132.

The cache system 100 gathers data from the monitoring device 120 and other sensors 118 for creating views and continuously updating the views in a cache to handle queries dealing with vast amounts of time series data. The system collects massive amounts of time series for remote monitoring and other applications. The system 100 organizes and stores the time series data for queries conducted for reporting, troubleshooting and analytics. For example, these queries may be long-running and repetitive, with similar queries being executed many times against the same data.

The system 100 creates views with results of pre-executed queries against time series data. The system stores the views in the context of a tag, asset model, or cached query list. As new time series data arrives, the views are updated on a continual basis against the live data, ensuring consistency across the system. The views are made accessible to future time series queries, resulting in faster query times and conserved system resources.

For example, graphing performance metrics for a gas turbine engine as depicted in FIGS. 1A-1B may require computing an average of a value from a particular sensor over the last 30 days of data. Pre-computing and caching the 30-day value eliminates the need to re-compute the average each time a graph needs to be produced.

The various sensors 118 throughout the system may provide operational data regarding the gas turbine engine 102 to the monitoring device 120. Moreover, the controller 122 may also provide data to the monitoring device 120. By way of example, the monitoring device 120 may receive and process data regarding the temperature within the engine, the pressure within the engine, the heat rate, exhaust flow, exhaust temperature, and pressure rate or a host of any other operating conditions regarding the engine 102.

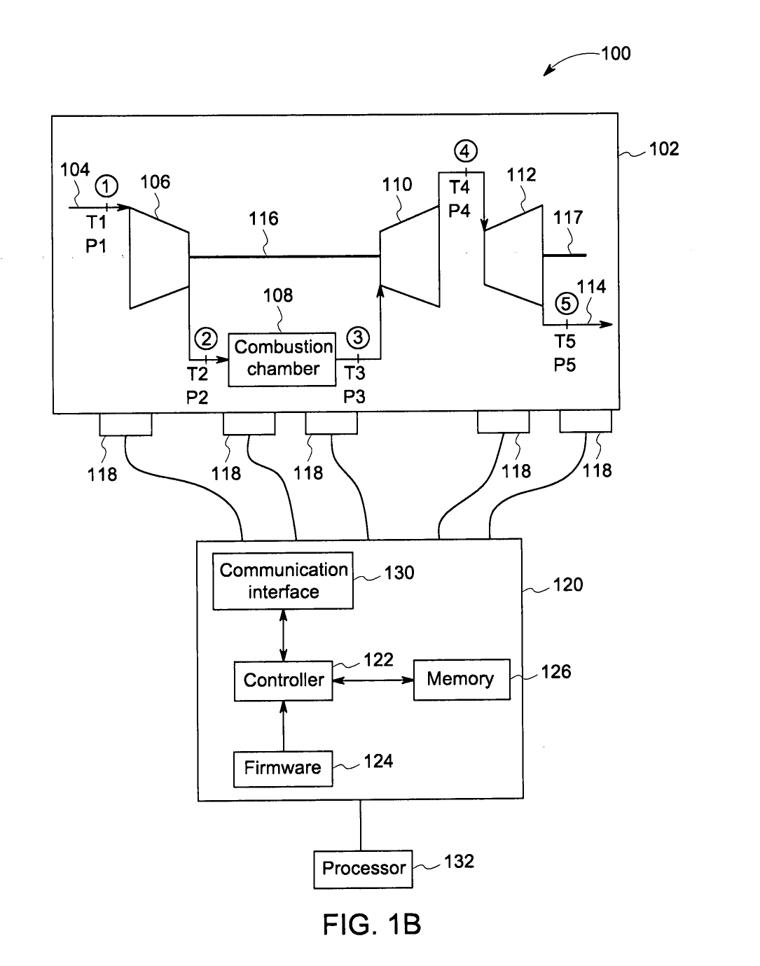

FIG. 2 is an illustration of multi-field dynamic array tags 200 in accordance with the present disclosure. Multi-Field and array tags allow users to define sets of data that will be stored and retrieved together.

The benefits of such tags include reduced storage requirements, faster read times, improved analysis (time-aligned queries). Array tags allow for multiple (dynamic) elements of the same data type, accessible through an array index. Multi-Field tags allow multiple values of any data type, accessed via user-defined field names.

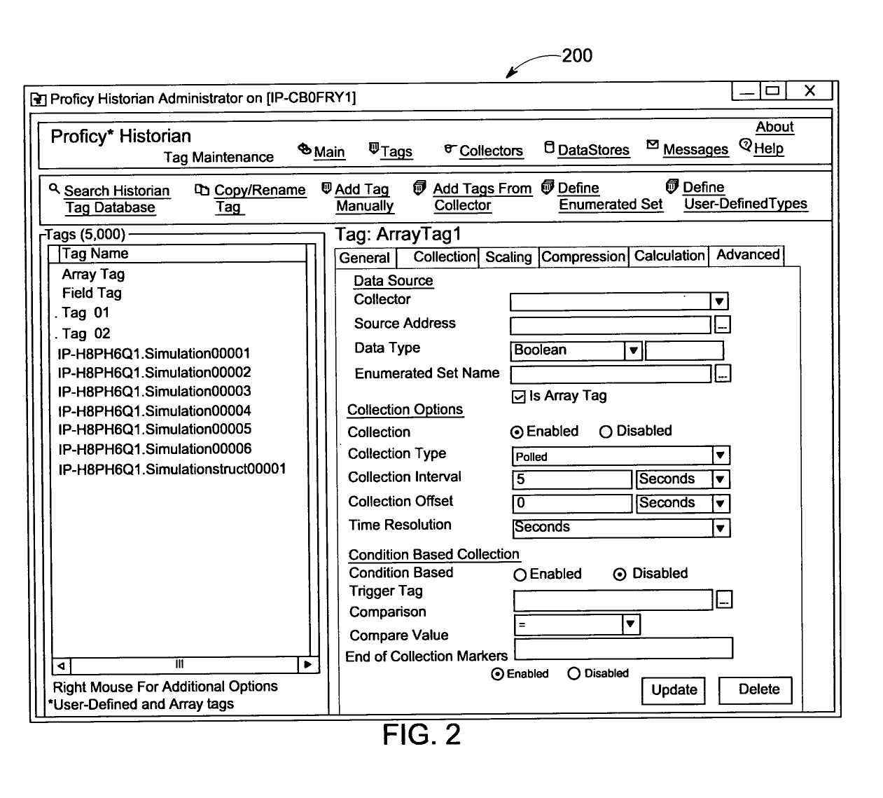

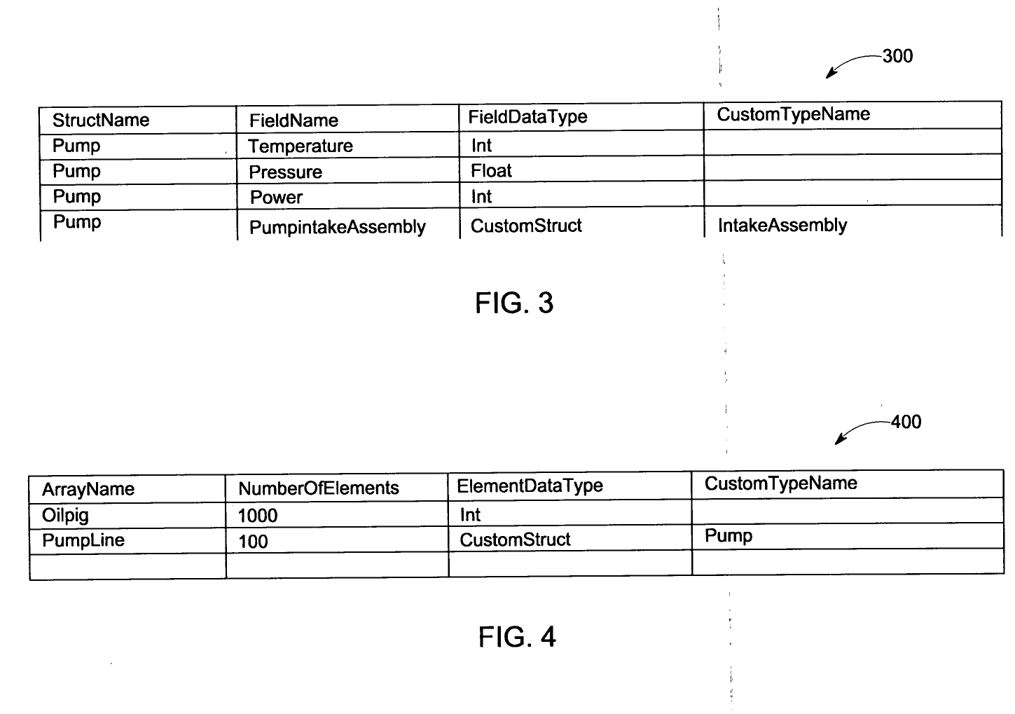

FIG. 3 is a more detailed illustration of an array 300 in connection with the illustration of FIG. 2. FIG. 4 is a more detailed illustration of a multi-field tag 400 in connection with the illustration of FIG. 2.

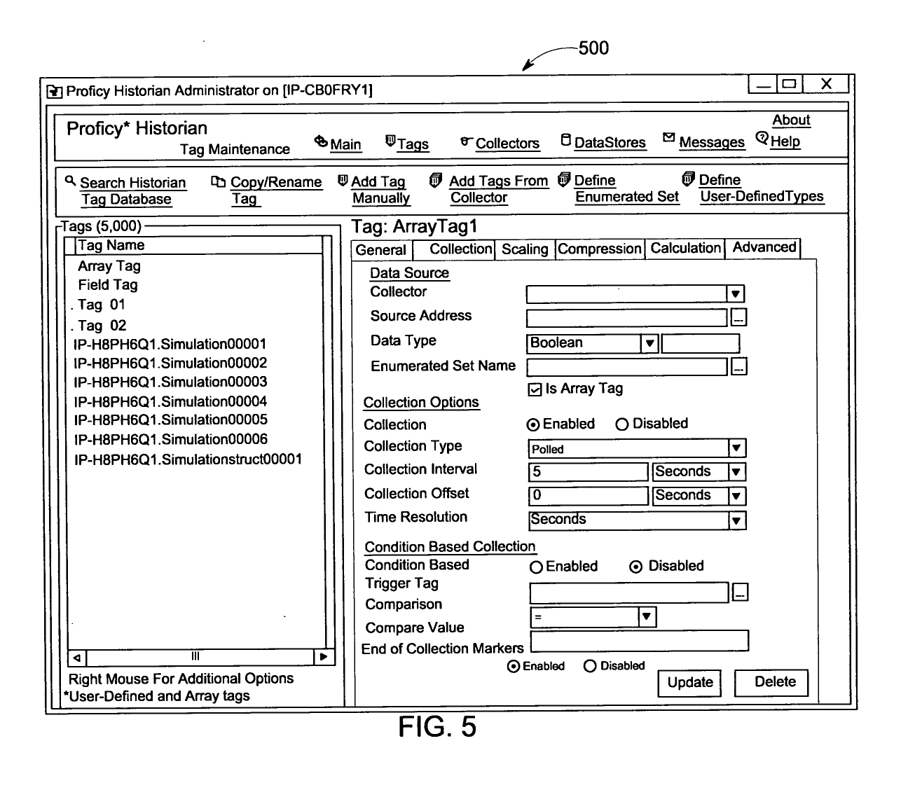

FIG. 5 is an illustration of a multi-field and array tag table 500 in accordance with the embodiments. In FIG. 5, the array tag table 500 is representative of a quality check station—pull product identification (ID) from a radio frequency (RF) tag (integer), quality tech input (text string), capture several images of quality issues (i.e., blobs), stored as a structure for accelerated retrieval.

The table 500 is also representative of oil and gas lines (O&G) pipeline inspection, enable an automated device to travel through pipelines looking for cracks and buildup, capturing hundreds of points of information concurrently from the circumference of the pipe. In paper applications, a scanner reads gauge data across the sheet as its being produced, gathering 5000+samples in a sweep, stored and utilized as an array. Combined with data stores, the use of the table 500 can provide an extremely powerful time-series data solution.

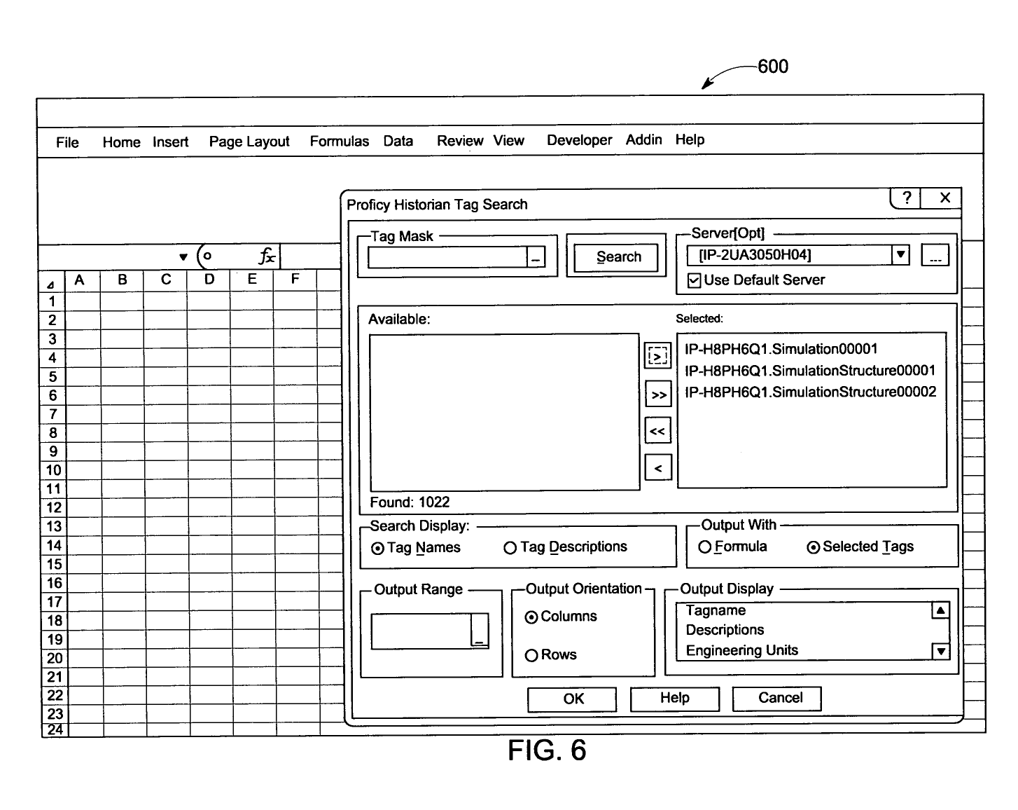

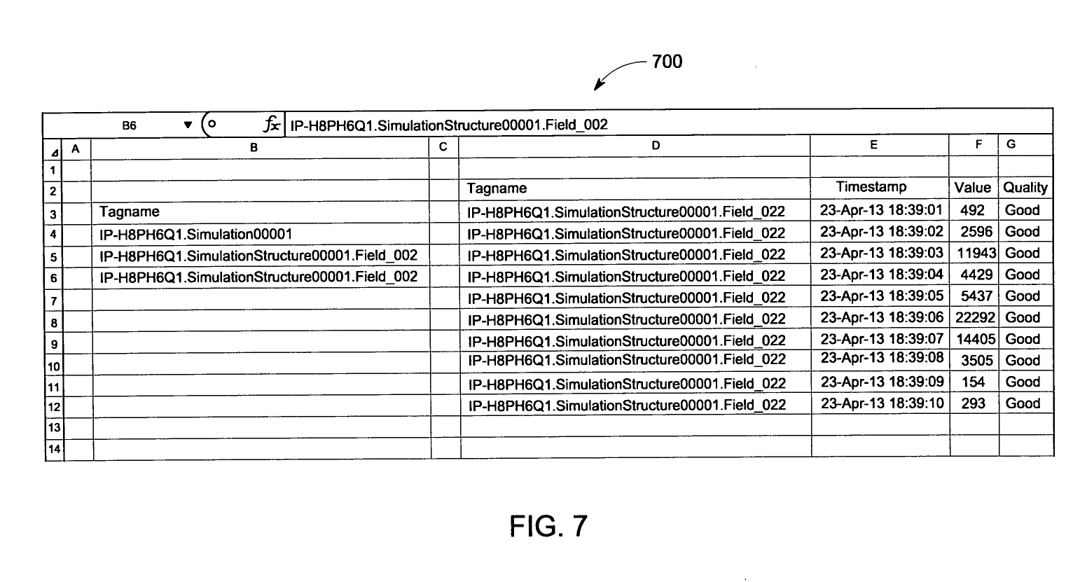

FIG. 6 is a first example 600 of arrays using excel in accordance with the present disclosure. In the example 600, a user can configure, query, import & export like any other tag. FIG. 7 is a second example 700 of arrays using excel in accordance with the present disclosure. More particularly, the example 700 is an illustration of performing a query at array element level.

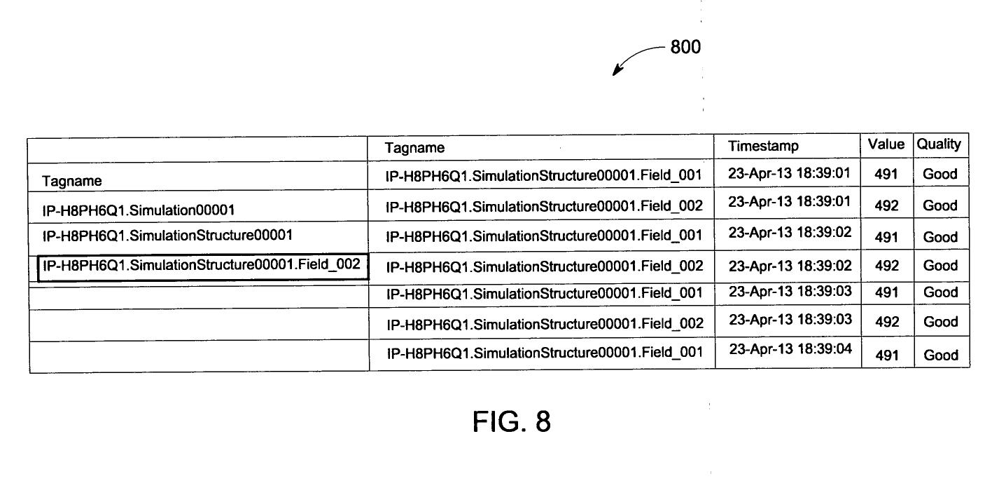

FIG. 8 is a third example 800 of arrays using excel in accordance with the present disclosure. More particularly, the example 800 is an illustration of performing a query for all array elements.

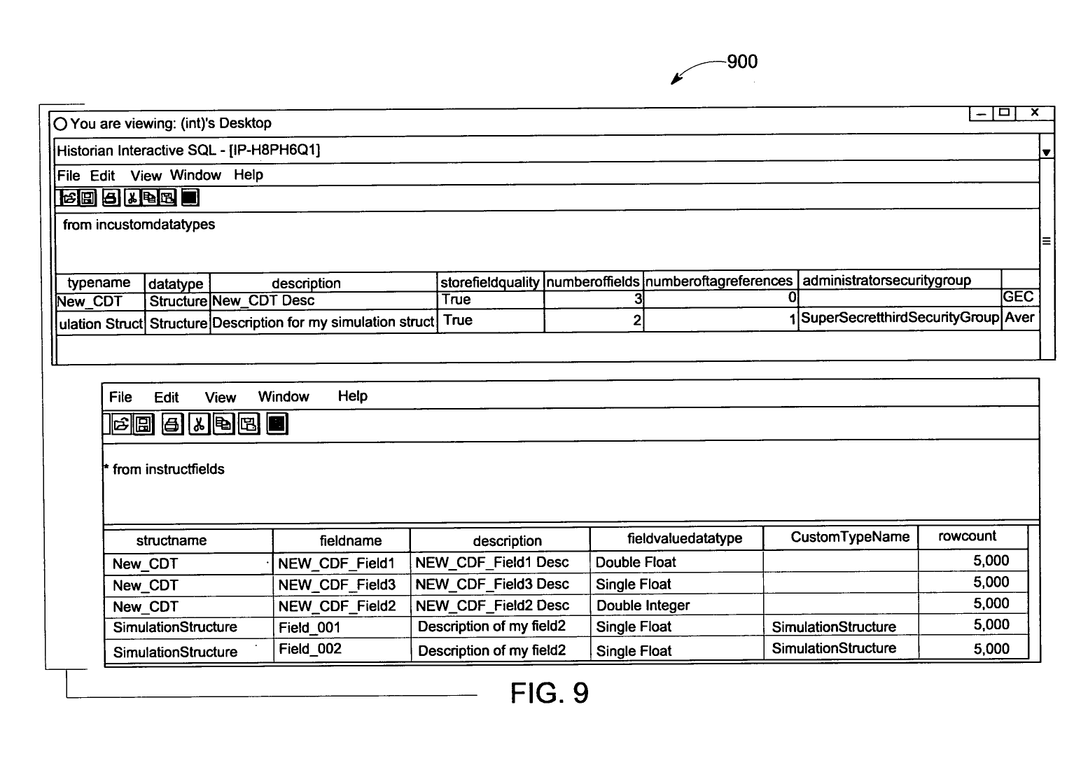

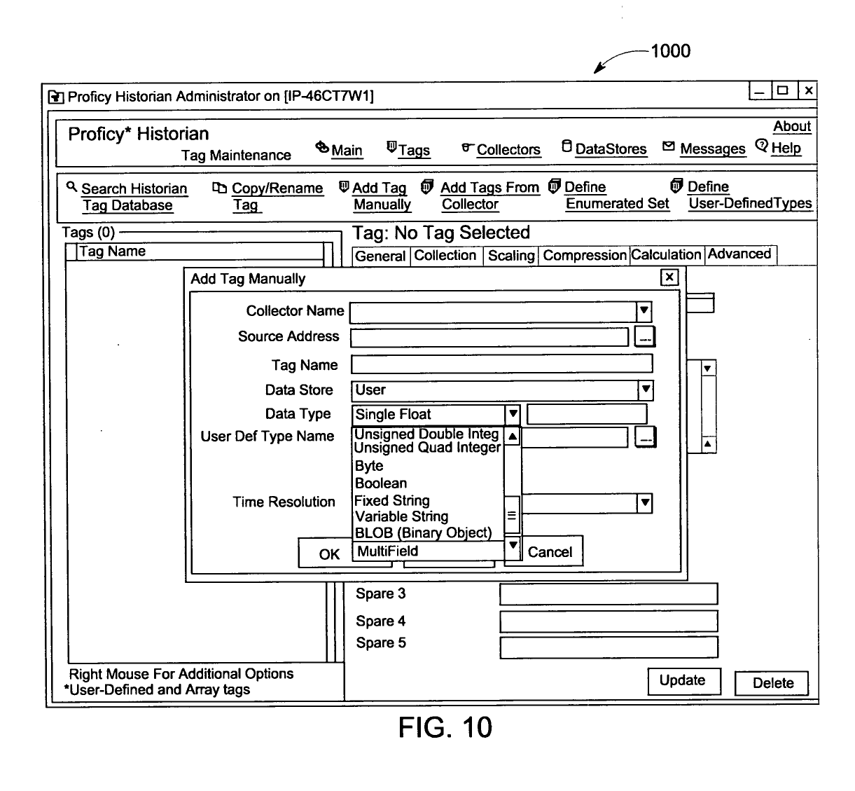

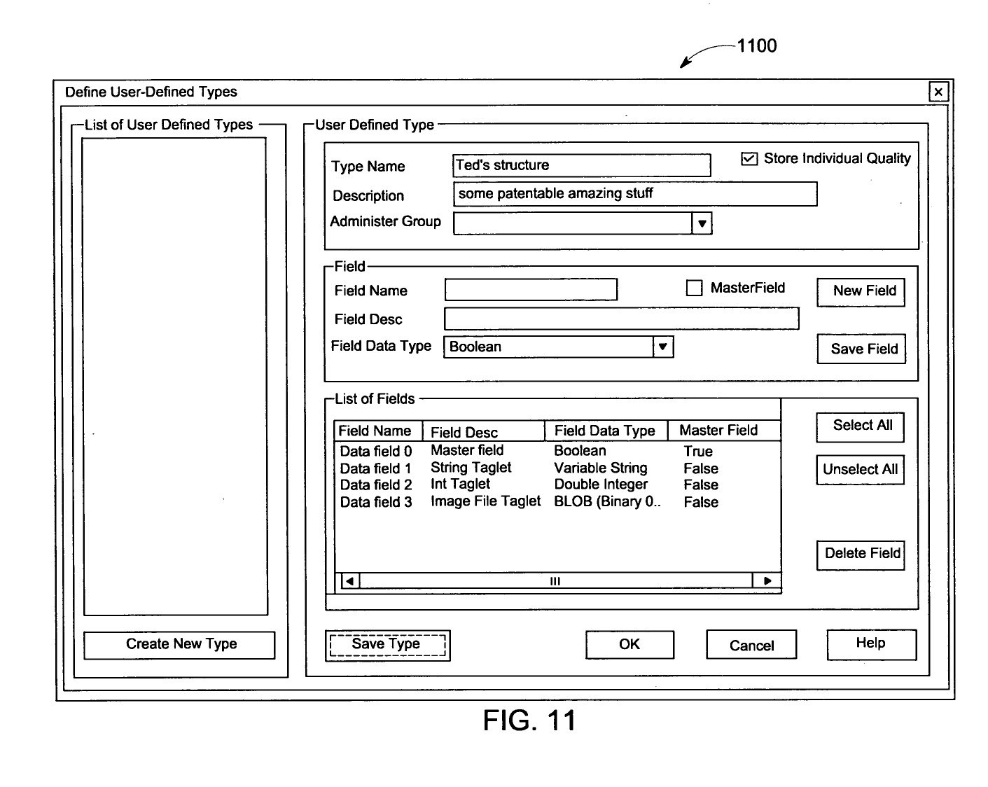

FIG. 9 is an illustration of multi-field in interactive SQL 900 in accordance with the embodiments. FIGS. 10 and 11 are illustrations of a process flow diagram of a method for creating and caching views for time series data in accordance with the present disclosure. In FIGS. 10 and 11, tables 1000 and 1100 would be selected like any other tag and mapped to the physical data points, respectively. As noted below, queries could then call these and ask for the entire structure, or just certain elements within the structure.

In the embodiments, improved performance of analytics by pre-organizing information in a manner most likely to be queried and co-location of data within the storage environment. More efficient storage of information via common time stamp. Improved flexibility and analytical performance via the ability to store multiple data types in a single logical unit. Improved analysis via ability to understand the containing structure from an individual element.

Disadvantages of conventional approaches include use a relational data base to store time series information. This storage typically results in reduced performance, less efficient storage, more resource intensive to manage. Another disadvantage includes pairing of a time series data store with a relational data store to contain “context” for the structure—more complex solution, likely impacting performance due to multiple steps in accessing and returning results, more resource intensive to manage.

Yet another disadvantage of conventional approaches includes storing a series of related information within a single data element (e.g. characters in a string) and parsing these as part of the retrieving query to understand underlying components. This is a more complex solution, likely impacting performance due to multiple steps in accessing and returning results, more resource intensive to manage, does not allow for multiple data types.

By way of background illustration, many existing companies perform data management. Included among these companies are Oracle and Microsoft, to name a few. Typically, these companies perform data management in a relational fashion. That is, they store information in a table or set of tables and in then tie those tables together. So for example, one table might have names, and those names might include first name and last name, which adds structure to the table. And there might also be a transaction associated with the name, such as a deposit having been made to a bank.

Additionally, in the preceding example, the transaction might also include a time element of when the deposit actually occurred. If so, there would be a money element of the amount of money that actually changed hands, etc. The bank, within its table information, might also refer to another table that has information about different banks in terms of geography, and a defined relationship between the first bank and the additional banks. This approach is representative of the traditional world of data management.

The conventional approach above can be beneficial in that there is a significant amount of structure and a number of relationships that can be relied on when trying to retrieve the data. This structure also is typically more read oriented so that when a user has the information in the database, the system is oriented towards retrieving information from the database. This approach is not necessarily oriented towards depositing information into the database rapidly, in the first place commit are a darn okay. For example, typically information is deposited into the database in the form of an overnight batch, which does not usually occur at high-speed.

A major difference between the environment of the aforementioned conventional approaches and the approach of the embodiments of the present invention is the use of a time-series process historian. Use of the time-series process historian grew out applications such as monitoring a wind turbine, or a gas turbine or sensors on a factory line, which are very high speed environment. That is, there is a high volume of information being presented to a user in real time.

Typically, this information includes read and write commands, which means that it's disadvantageous to overlook any incoming information. At the same time, the user would be looking for the information back very quickly in that another operator mighty be analyzing this data to perform a trend analysis in real time. As understood by those of skill in the art, the retrieval of this information is referred to as keying.

In the world of conventional approaches, there could be many keys that can be used to facilitate information retrieval. More specifically, in the time-series world, the primary key is time and essentially the only key that exists in the process historian.

In most cases, for example, time is represented by a flat file with an entire string of information all in one table: It's time, data, and the quality of the data. The data could be different data types in that one could have, for example, an integer, a string such as a text string, a set of numbers, and/or an image file.

One of the other unique features about time-series and about process historians is that the reason they can insert data so rapidly and efficiently is because in time-series, only the change of a value for a particular table is recorded. Although a table entry might change, if the value of the entry remains the same, the user would not write anything in but would merely note that the only thing that changed from time A to time B was the time. Therefore, this approach is very efficient for getting data into a table. And this feature is accomplished, in part, through the use of compression models that are used to get large volumes of information into a single place.

By way of background, in conventional time-series approaches, there has always been an ability to record data, including different types of data, and all of these different types of data might occupy their own row in the table. And those rows get shuffled around enabling one to write all of the data back into the table. These rows tend to exist as individual elements with only time as the key.

In the embodiments, there is an ability to store multiple data types under a single time element. For example, a user may have one timestamp or key, but a significant amount of information can be collected in relation to different data types. One could have many integers that were all recorded at the same time. Or one could have multiple data types.

For example, an image file, string, an integer could all be recorded as part of the same structure. Thus, the approach of the embodiments is a type of hybrid between the time-series and the relational world, but accomplishing it purely within the environment of time-series.

Other conventional approaches also have the ability to relate. These other conventional approaches relate by folding a relational database onto a time-series database. Thus, they capture all of the information from one side and on the other side, they utilize context models, which define how the data is organized. Next, they determine which things go together and organize the information in that manner.

Embodiments of the present invention establish a structure and an ability to manage multiple data types, all within the environment of pure time-series. Consider the example of a quality check station having a part that comes down on the line is an anomaly. In this example, a user would first retrieve the radiofrequency identification (RFID) from a part tag identifying the part. At the same time, however, the system would collect additional information related to the part.

For example, perhaps the part conducted some measurements at the same time instance. So maybe instead of integers, these are floating data types. Also at the same moment, a camera could have taken a snapshot of three different angles of the part that shows what it looks like. Thus, at this exact time with those precise measurements, here's what the part looks like.

In other words, the system is capturing this information and storing it in the same spot within the users predefined data structure. So the embodiments are able to compress it, and leverage all of the compression techniques that process historians perform, and store it very rapidly. The system is also able to correlate the data above within the data structure so that users do not have to physically hop around on a disk to retrieve the information. Therefore, retrieval happens very quickly, because when the data is requested, it can easily be retrieved, having been stored right next to the value of the RFID in the image file. This process helps retrieve information very rapidly, which in turn helps with analytics.

Other conventional processes include the use of arrays. Arrays are a subset of the multi-field structure, discussed above. An array, for example, can be thought of as a one-dimensional structure and can be stored in similar fashion.

Embodiments of the present invention accommodate and store structural information that, within a hierarchy, can have different data elements. The order of the information can matter, and storage and retrieval of everything can occur concurrently and in a nested manner. For example, the overall user defined data type might be a type of a pump. Underneath the pump, within the structure, there may be a picture file that includes seven strings, characters, and a few integers and everything else associated with defining a pump.

Within this structure, one could also have a sub component of a pump which would have its own structure. This subcomponent information could also be stored as a time-series. Therefore, the embodiments include a nesting capability that is also unique about the embodiments of the present invention. Nesting is not necessarily unique to the relational world. However, nesting is unique in the time-series world, especially in the matter achieved in the embodiments.

The embodiments provide efficiencies of write commands where gathering the information is where one retains a lot of the speed and compression that is common in the time-series world. There are efficiencies achieved on the network because the system is not transporting large amounts of information. That is, even something as simple as a timestamp might have 16 characters associated with it, along with information related to an appropriate time zone. This information can be processed very quickly. This can be extremely significant, especially in remote locations where a cellular connection might only exist for a few seconds and bandwidth becomes a premium.

On the disk side, or pure data management side, information can be stored efficiently and concurrently. This process also has benefits on the read side because the read commands are now much more efficient. And one can derive structural information out of those read commands without having to reference additional information. In the embodiments of the present invention, all of that information is stored in one place.

Because the reference point is still time, storage of different data types is permitted. One of those data types can in fact be a multiple-field data types. The embodiments can essentially have more than one structure at the same time. Because it's all dynamic, one can insert the additional information and it remains in sequence. For example, systems constructed in accordance with the embodiments still know that element 2 was an integer, element 3 was a multi-field, and element 3a was a floating-point, and element 3b was an image file. But when the systems moves on from element 3, which is a nested multi-field, to element 4, the original structure can be retained because the system has not moved on from the original storage pattern.

Again, other convention approaches include the use of relational databases, such as Oracle. Another approach involves a combination type system, such as bolting on a relational system, which includes all of the context information or the structure. Thus, when one has a data element that includes a name, if a query is performed, that query will first hit a layer that will define what is being searched for, and what's related to it. Once the search target has been disclosed, the system will go back in and comb the time-series looking for lists for elements that are tied to that structure. In the conventional approaches, these elements are not old co-located, so it will be difficult to pull all of this information together. The conventional approaches, therefore, take longer and are less efficient.

The embodiments provide extreme efficiency and the tailorability/flexibility/simplicity of systems designed in accordance with the embodiments allows one to optimize their data management and data lifecycle in various ways. The embodiments perform in an extremely high-speed world in ways that bolt on or relational approaches will not work. Therefore, aspects of the embodiments are applicable example environments beyond industrial control systems.

For example, process historians can be used to catalog all of the stock transactions as they are taking place, or applied to other aspects of the financial market. Time-series systems constructed in accordance with the embodiments can also be applied in the healthcare industry. One can consider the example of use of electrocardiogram (EKG) machine taking 12 different data points associated with imaging in patient's heart at different angles. Each angle is associated with a waveform with some other structure. This is especially applicable when comparing different data types, for example, also conducting an x-ray, along with some other medical procedure that is to be correlated with the EKG data.

Basically a great example of multi-field is adding global positioning system (GPS) coordinates to time-series data so that this can be applied so one can apply to any industry or application that requires sample+altitude/lat/long/GPS (airplanes, truck driving data capture, locomotives). The approach of the embodiments can also apply to any application that uses Geo-fencing in conjunction with high speed.

Other example environments in which embodiments of the present invention may be applicable include financial stock tracking (structure might be something like: time, value, stock type, buyer, seller), health care (waveform from EKG, perhaps combined with other data types like eye pressure or temperature, synchronized), transport/in-vehicle applications (airplane or train black box, car), and/or other.

For example, there might be a temperature sensor associated with the patient's eye that recorded a spike at some point in time, which might be related to the EKG results or the patient's heart rhythm. The embodiments could also be applicable to the aviation industry in recording and analyzing black-box data. It might also applicable to the locomotive industry, for the automotive industry, or anything related to telematics.

By way of background, the process historian pre-organizes in preparation for retrieval, i.e., prestoring, related items to expedite retrieval. As understood by those of skill in the art, nesting, is performed by defining the structure: user-defined data-types within the time-series environment. A subset of this is called multi-field, or structures. Next, an entity can be created to have the following data elements in the following order. For example tag lit 1=integer value (RFID being pulled off of the scanner), tag lit 2-4=images taken from 3 different angles, tag lit 5=name of person standing station because they scanned themselves in, and that will be a string. More elements can be added or other elements can be erased.

The embodiments of the present invention also includes dynamic sizing, which is related to arrays, discussed above. The embodiments can also dynamically flex, which means related systems to not need to know that the information coming in will be a particular number of data elements. This is an adaptive data management technique for handling structured information that is being served into a time-series system

The embodiments provide an ability to store variable size multi-field data efficiently (variable size data buckets to accommodate and multi-field), including blobs—faster to read—this is requirement for high definition (HD) as you have to read in sequence, offsets don't matter. Metadata is efficiently stored along with data in the same media. Although the definition can change over time, precise metadata that existed at that time, is stored. The embodiments of the present invention avoid not “versioning” the metadata outside. In the embodiments, an exact copy of the metadata is retained. This approach provides portability of data—integer is simple because it remains an integer, where multi-field can evolve.

At an individual field level, the embodiments avoid storing data that has not changed. The embodiments are different than lossy or standard compression used in historians, more like traditional disk compression techniques. An embodiment of the present invention also includes an ability to define a master field which can store quality at structure level or at element level, providing further efficiencies.

Embodiments of the present invention may be made by those skilled in the art, particularly in light of the foregoing teachings. Further, it should be understood that the terminology used to describe the disclosure is intended to be in the nature of words of description rather than of limitation.

Those skilled in the art will also appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A method for performing data management in a high-speed data environment comprising:
collecting time-series information including multiple data types captured concurrently;
storing the collected time-series information in a process historian; and
organizing the information, wherein the organizing occurring when the multiple data types are captured.

2. The method according to claim 1, wherein organizing the information comprises defining a database position for each data type within the time-series information and storing the time-series information composed of multiple data types in the same database position for each process historian time-series entry.

3. The method according to claim 1, wherein organizing the information further comprises adding or subtracting database positions from the process historian.
